(19) United States
(12) Patent Application Publication
(10) Pub. No.: US 2003/0088992 A1
(43) Pub. Date: May 15, 2003

(54) Guide for cutting corrugated sheet material

(76) Inventors: Robert Nelson, Wyoming, MI (US); August Katsma, Wyoming, MI (US)

Correspondence Address: Waters & Morse, P.C., 400 Ledyard Building, 125 Ottawa Avenue, NW, Grand Rapids, MI, 49503, US

(21) Appl. No.: 10/277,353

(22) Filed: Oct. 22, 2002

Related U.S. Application Data
(60) Provisional application No. 60/347,986, filed on Oct. 22, 2001.

(51) Int. Cl. G01D 21/00

(52) U.S. Cl. 33/640

(57) ABSTRACT

A guide for marking or cutting at an oblique angle corrugated sheet material for buildings, decks or the like comprises a base that is mounted on the surface of corrugated sheet material by means of clamping members that grip the corrugations on the face or surface of the sheet material. A protractor rotatably mounted on the base include a straight edge that provides a guideline for a marking tool or cutting tool. The straight edge can includes a number of interconnectectable or hinged extension sections that can be used to provide a longer straight edge for marking a guide path over a considerable width of sheet material. The present invention is a lightweight, relatively inexpensive and relatively compact tool that can readily be used on the job site for making accurate, oblique cut lines in large siding panels.

### CROSS-REFERENCES TO RELATED APPLICATIONS

This is a non-provisional application based on and claiming the filing priority of co-pending provisional patent application Serial No. 60/347,986, filed Oct. 22, 2001, which is incorporated by reference.

### BACKGROUND OF THE INVENTION

The present invention relates to a guide for cutting corrugated sheet material at a building site.

Corrugated sheet material, usually sheet metal, is commonly used for a variety of purposes, including the outer walls or skin of pole buildings and decks. Such materials are fabricated in large rectangular panels that are typically about 36-38 inches wide and can be forty feed long. When such panels are used in building construction, the ribs or corrugations are usually oriented vertically, and adjacent sheets are overlapped in order to form the building panels. Typical corrugations have straight sides that are inclined at an angle of about 65 degrees. Other angles and arcuate corrugations are known. When the building panels are used at the gable ends of a building, the upper ends of the sheet metal panels must be cut at an oblique angle to conform to the pitch of the roof. The pitches of different roofs vary, but the pitch is generally known. Also known is the height of the panel at the lowest end of the oblique angle. It is generally a challenge, however, to cut the upper end of the panel at the proper height and oblique angle so that the upper end of the panel fits properly to the underside of the building roof.

Sheet metal cutting guides for flat sheets are known, and these sometimes incorporate protractors for cutting at an angle. However, such guides are generally not readily adaptable to corrugated materials and require clamping on the edges of the material. Shears for cutting corrugated sheet metal at straight or oblique angles also are known, but these are generally cumbersome and expensive and cannot be used with power tools.

An object of the present invention is to provide a relatively simple, transportable guide for cutting oblique angles in corrugated sheet material that can be easily transported to and used at a work site.

### BRIEF DESCRIPTION OF THE DRAWINGS

FIG. 1 is an elevational view of a gable-end of a pole building showing the corrugated siding cut that is to be accomplished with the guide of the present invention.

FIG. 2 is an elevational view of a corrugated panel on which the guide of the present invention is mounted for establishing an oblique cut line on an upper end of the panel.

FIG. 3 is a sectional view taken along line 3-3 of FIG. 2.

FIG. 4 is a front elevational view of one embodiment of the guide of the present invention.

FIG. 5 is a plan view of a two section extension straight edge of the present invention.

FIG. 6 is a fragmentary perspective view, shown partially broken away, of the joint between the two sections of the extension straight edge of FIG. 5.

FIG. 7 is a fragmentary view showing the connection between the extension straight edge and the first straight edge segment shown in FIG. 4.

FIG. 8 is a fragmentary side elevational view showing the hinge joint wherein the two sections of the extension straight edge are folded together.

FIG. 9 is a perspective rear view of the guide of the present invention.

FIG. 10 is a perspective view of a second embodiment of the guide of the present invention.

FIG. 11 is a fragmentary perspective view of the guide bracket in which the straight edge is mounted on the protractor in the embodiment of FIG. 10.

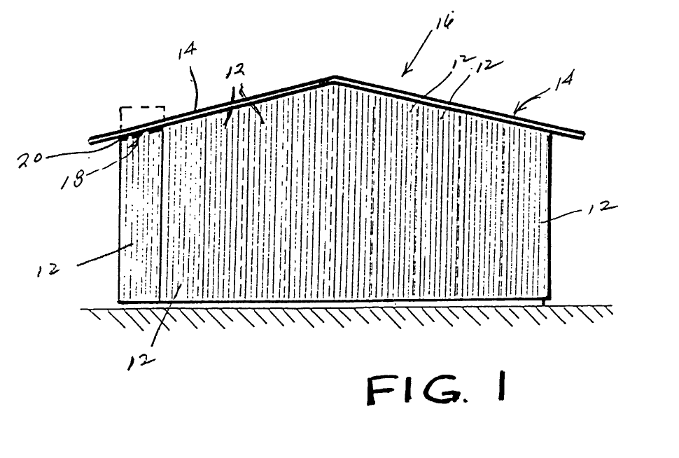

### DETAILED DESCRIPTION OF PREFERRED EMBODIMENT

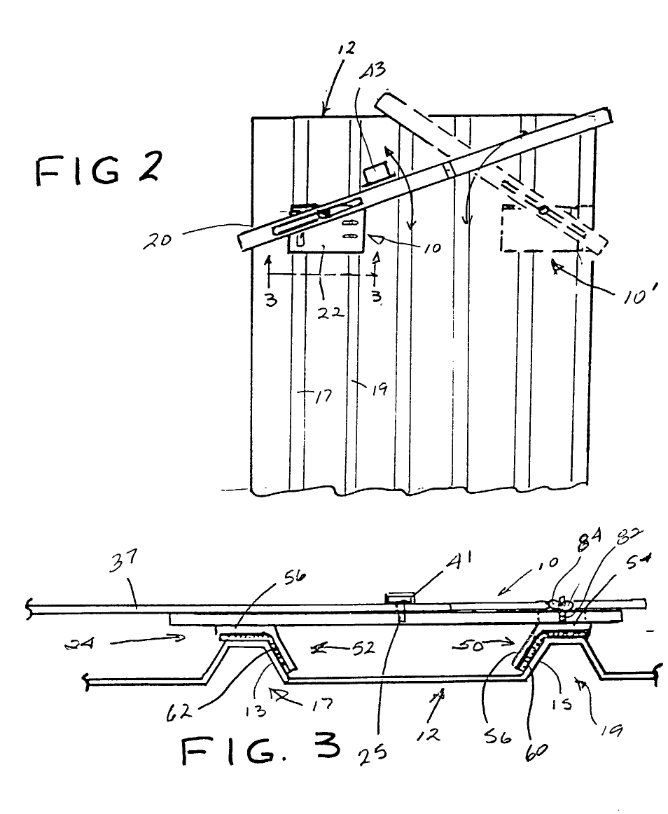

Referring now to the drawings, guide 10, shown in use in FIG. 2, is designed to provide a means for providing an accurate oblique cut line in rectangular corrugated panels 12, which are typically arranged side by side in overlapping fashion to form a wall or deck. The present invention is particularly well-suited for cutting corrugated metal panels to fit the underside of a gabled roof 14 in a metal building 16, wherein an oblique cut line 18 needs to be made in each panel 12 in order to mate with the underside of the gabled roof 14. Such a cut needs to be made on site and desirably is made with a tool that has a cost effective price. In making such a cut line 18, the fabricator usually knows the height of the panel to the lowest end 20 of the cut line, and he also knows or can measure the angle of the cut line.

The guide tool 10 of the present invention is shown mounted on a corrugated panel 12 in FIG. 2. Guide tool 10 comprises a plate-shaped base 22 that is adapted to be mounted on the face or surface of corrugated panel 12 by means of a clamping mechanism 24 on a rear side thereof (FIGS. 3 and 9) that engages opposed outwardly extending surfaces 13 and 15 of corrugations 17 and 19 on the surface of the corrugated sheet material.

A straight edge or ruler mechanism 37 is pivotally attached to base plate 22 by means of an elongated longitudinal slot 39 in the interior of ruler 37 that fits over pivot pin 25. Desirably, pivot pin 25 is threaded into ruler or support arm 31 by means of a clamping knob 41. Rotation of clamping knob 41 into the base plate clamps ruler 37 in a desired angular position with respect to the base, whereas unscrewing the clamping knob releases the ruler and permits pivotal movement and longitudinal movement of the ruler with respect to the base. Ruler 37 is first section of a straight edge guide, with other sections being attachable thereto. An assembly comprising rulers 31 and 37 and clamping knob 41 is available commercially. Rulers 31 and 37 are formed of light weight aluminum in the commercially available form.

Ruler 37 can be used for purposes of marking a guide line on corrugated sheet material or it can be used as a cutting guide for a saw 43, shown schematically in FIG. 2. When used as a guide for a saw, it is desirable to have a protective lip on the edge of the straight edge so as to prevent damage by the saw and to provide a larger guide surface for the saw along the straight edge. A U-shaped edge guard 45 formed of steel and having upwardly extending flanges 47 that are at least a ¼ inch high provide protection for the ruler and a substantial guide surface for saw. The edge guard flanges 47 fit snuggly on the sides of straight edge 37 and can be mounted in place by screws or pins 49. An outer end 51 of the edge guard extends beyond of the end 53 of ruler 37 in order to provide support of an extension straight edge 53 (FIG. 5). Ruler or straight edge 37 desirably is a scaled ruler 48 inches long. However, where measurements are not needed, the straight edge could simply be a straight edge of any length without a measurement scale thereon. A ruler 48 inches long is desirable.

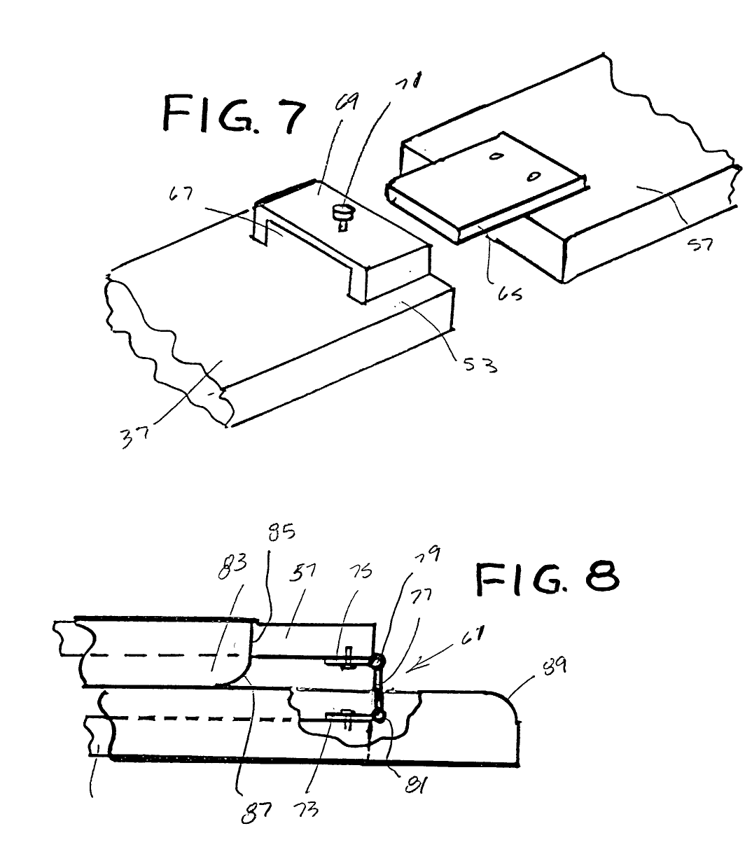

When a longer straight edge is desired, extension straight edge 55 can be attached to the outer end 53 of the first straight edge section 37. Extension straight edge 55 desirably is formed in two sections 57 and 59, both of which are 48 inch rulers. The rulers are connected together by a hinge mechanism 61, which is shown in more detail in FIG. 6. An inner end 63 of the inner ruler 57 includes a tab 65 attached to an upper surface thereof that extends outwardly from the end of the ruler. As shown in FIG. 7, tab 65 fits in a mating opening 67 in a mounting block 69 mounted on the outer end 53 of ruler 37. A set screw 71 extends through a threaded opening in an upper surface of mounting block 69 into contact with tab 65 when tab 65 is inserted in opening 67. The set screw can be tightened to lock the tab in place and thereby lock the extension straight edge in an end to end position with respect to the first straight edge 37.

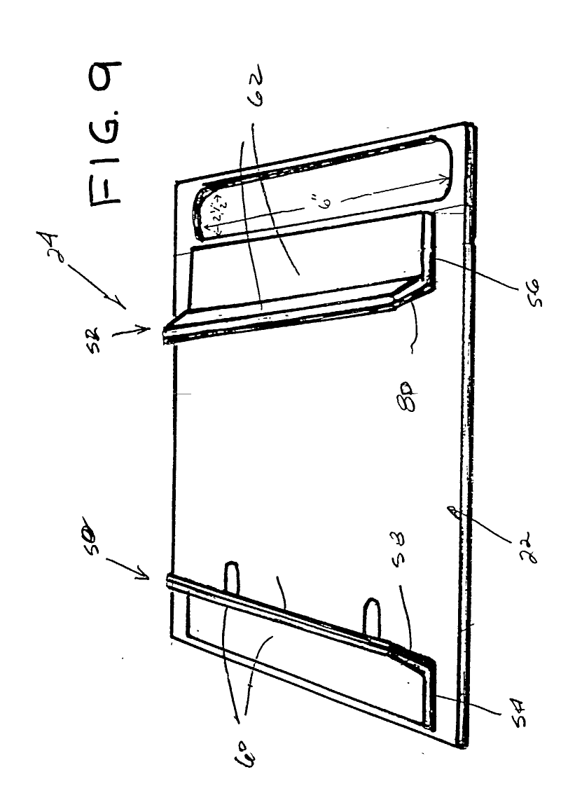

The hinge mechanism 61 is shown in more detail in FIGS. 6 and 8. Because flanges 47 of the edge guard 45 extend upwardly beyond the upper surface of ruler 37, a three section hinge 61 is employed so that the two sections of the ruler will fold flat against each other in the manner shown in FIG. 8. The three section hinge 61 comprises a first plate 63 attached to the upper surface of ruler 37 and a second plate 75 attached to the end of ruler 57. An intermediate section 77 is connected by pivot pin 79 on one end to plate 75 and by pivot pin 81 to plate 73 on the other end. Intermediate section 77 lets the rulers fold together flat as shown in FIG. 8.

As shown in FIG. 6, end 51 of edge guard 45 extends beyond the outer end 53 of ruler 37, in order to support extension straight edge 55 at the place where the two sections are connected. A separate edge guard 83 is mounted on extension straight edge section 57. This edge guard has an inner end 85 that is spaced away from inner end 63 of the straight so that it is spaced away from the extended end 51 of edge guard 45. The upper corners 87 and 89 of the edge guards are rounded so that they can fold over one and other when the rulers collapsed.

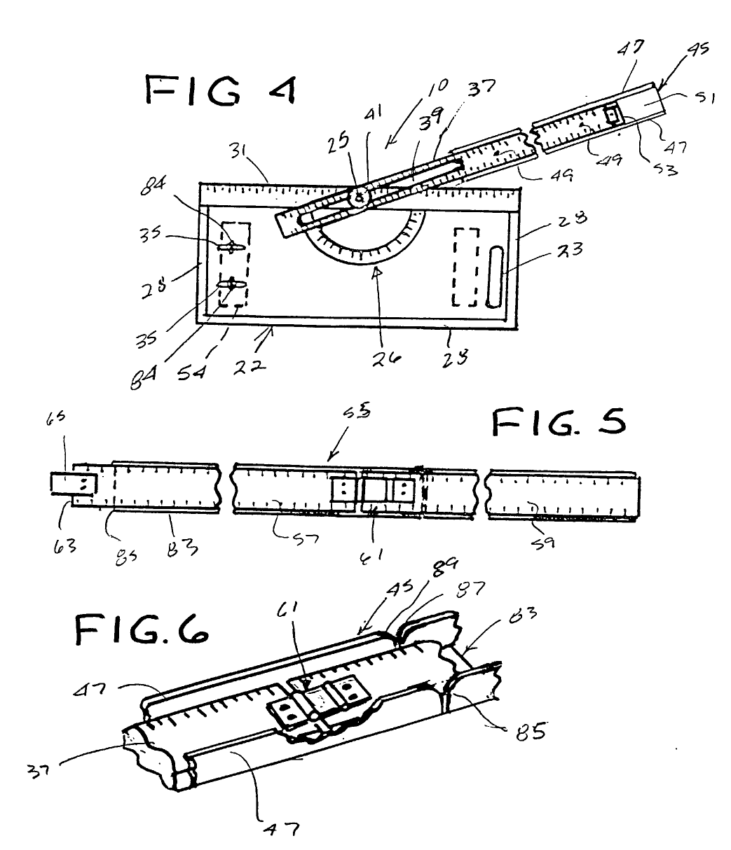

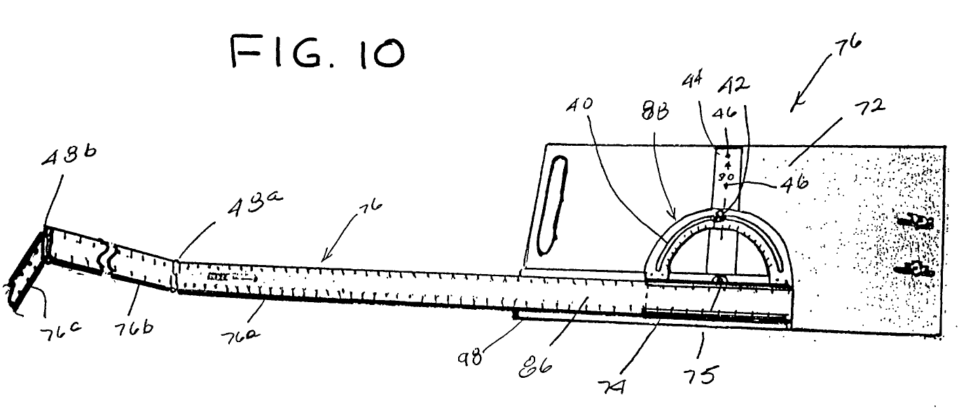

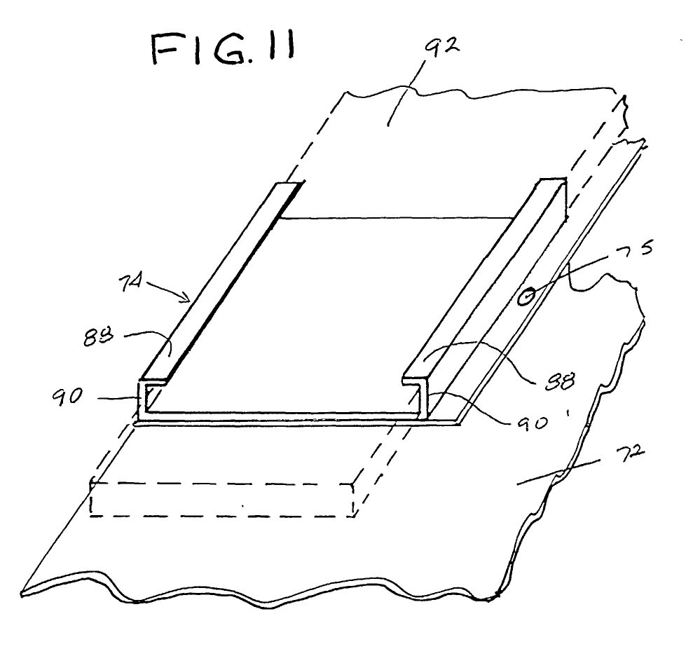

As shown in FIG. 2, the guide of the present invention can be adapted to mark a guide line to the right of the guide tool, as indicated by solid FIG. 10. Alternatively, the ruler can be pivoted to the left, as shown in phantom in FIG. 10′,in order to mark a panel with a slope in the opposite direction. Another embodiment of the protractor mechanism 76 is shown in FIGS. 10 and 11. A protractor 26 is mounted on the face or front surface of base 22. One embodiment is shown in detail in FIG. 4. Base 22 is a rectangular plate having an elongated hand opening 23 at an end thereof for carrying the guide tool. A base formed of 18 gauge plate 12 inches long by 26.5 inches wide is satisfactory, but other sizes will work.. A ridge 28, which is a strip of reinforcement material, extends around three side edges of the plate. The forth edge of the plate is reinforce by a flat support arm 31 in the form of a ruler section. The ridges and ruler reinforce the base plate and space the protractor above the base plate. Longitudinal slots 35 are positioned adjacent opposite ends of base plate 22 for attachment of a clamping mechanism thereto.

The protractor mechanism includes a guide bracket 74 for supporting a straight edge or ruler 86. The guide bracket includes a generally upwardly facing U-shaped bracket having inwardly extending flanges 88 on upper edges of sidewalls 90 of the U-shaped bracket, such that the metal straight edge or ruler 86 can fit in the guide bracket and slide longitudinally therein but is otherwise retained in the bracket. The guide bracket is mounted on support arm 98, which is mounted on the bottom edge of plate 72. The protractor also includes an arcuate portion 88 attached at the side of guide bracket 74 for rotation therewith. Arcuate portion 88 has an arcuate slot 40 therein that extends through an arc of preferably 180 degrees. The arcuate slot defines the arc of a circle having its center at the axis of rotation of the guide bracket, which is pivot pin 75. The arcuate portion preferably is provided with legible markings showing the angle of inclination of the guide channel with respect to the base plate. A locking mechanism 42 comprises a screw extending upwardly from transverse strip 44 through groove 40. A wing nut mounted on the outer end of the screw can be tightened in order to clamp the arcuate portion protractor at any desired angular orientation of the guide bracket.

A straight edge or ruler 76 is mounted in guide bracket 74 for slidable longitudinal movement in the guide bracket. Desirably, the straight edge is a 48 inch metal ruler, which is conventional. Even more preferably, a plurality of metal rulers 76a, 76b, and 76c are connected together end to end by hinges 48a and 48b. Preferably three 48 inch rulers are connected together in this manner, providing a total guide extension of 144 inches or twelve feet. The hinges are preferably connected on opposite sides of the ruler so that the ruler will fold together in accordion fashion for purposes of storage or transportation.

The clamping mechanism 24 of the present invention is shown in more detail in FIG. 5. This clamping mechanism is used for both embodiments of the protractor but is discussed for exemplary purposes in connection with the first embodiment. Clamping mechanism 24 comprises a pair of elongated angular members 50 and 52 about 10 inches long that are mounted in alignment with each other but spaced apart on the back of base plate 22. The angle members are substantially the same but are oriented in opposite directions from each other, with the angle members having mounting flanges 54 and 56 that lie flat against base plate 22, while clamping flanges 58 and 80 extend outwardly from the mounting flanges at opposite inclined angles, which are at least 45 degrees and preferably about 65 degrees. An angle of 65 degrees provides a desirable angle for engagement with corrugations of the most commonly used materials. Desirably, rubber gripping surfaces 60 and 62 are applied to the surfaces of the clamping members that engage the corrugations in the corrugated sheet material. A rubber gripping surface avoids scratching the panel and provides a resilient surface that tends to conform to the shape of the corrugations and also provides an increased coefficient of friction to increase the gripping force of the clamping members. Clamping member 54 is mounted in slots 35 by means of screws 82 and wing nuts 34 so that the clamping member position can be adjusted transversely with respect to the other clamping member. The other clamping member can be fixed in position by welding for fasteners. The clamping members operate clamp the base onto the surface of a corrugated sheet material by placement of the clamping members between the corrugations of the sheet material and then sliding the clamping members apart until they are snugly engaged against outwardly extending surfaces 13 and 15 on opposite sides of corrugations 17 and 19 of the corrugated sheet material, as shown for example in FIG. 3. The shape conforming characteristics and the coefficient of friction of the rubber surfaces and the angular inclinations of the clamping flanges restrain the clamping members from slipping off of the corrugated surfaces.

In order to employ the present invention for the purpose of making an oblique cut at an upper portion of a corrugated panel, it is first necessary to determine the length of the panel at the shortest distance to point 20 (FIG. 2). Knowing the angle of the roof line (or just measuring it with the protractor), the protractor can first be applied to the surface of the panel, and the straight edge can be aligned at the proper angle. The clamping mechanism is then slid longitudinally along the panel until one end of the straight edge is positioned at the proper length on the panel. The clamping member is then locked in position and the straight edge assembled with extensions attached or unfolded to the extent necessary to extend all the way across the panel. The straight edge can then be used as a guide for a power saw or manual saw to cut the panel, or the straight edge can be used as a ruler to mark a line across the panel. To the extent that the straight edge is used for a guide for a saw, a raised edge of about ¼ inch placed along the edge of the straight edge provides a guide for the saw and prevents the saw blade from accidentally striking the straight edge. The U-shaped channel of the first embodiment can be used.

The foregoing invention provides a simple, compact, and highly effective means for establishing a cut line on paneling used for building siding. The same application can be applied to the use of corrugated decking or virtually any other application using corrugated sheeting. The present invention is inexpensive, and is easy to store and transport.

It should be understood that various changes and modifications may be made in the arrangements and details of construction of the embodiments disclosed herein without departing from the spirit and scope of the present invention, as defined in the attached claims.

I claim:

1. A guide for establishing an oblique cut line on a sheet of corrugated material comprising:
a base;
clamping means on the base for clamping the base to the surface of a sheet of corrugated material by engagement of relatively movable clamping means with outwardly extending surfaces of corrugations on the face of the sheet material;
a straight edge rotatably mounted on the base for rotation in a plane parallel to the plane of a sheet of corrugated material to which the base is clamped; and
clamping means for releasably securing the straight edge in a desired rotational position with respect to the base.

2. A guide as in claim 1 wherein the guide further comprises a measurement scale that provides a legible reading representative of the angle of inclination of the straight edge.

3. A guide as in claim 1 wherein the straight edge comprises an elongated guide strip formed of material having a straight edge on at least one side thereof, the guide strip being mounted for longitudinal movement in a guide bracket, the guide bracket being rotatably mounted on the base.

4. A guide as in claim 3 wherein the straight edge comprises a plurality of guide strips connected together, the guide strips being collapsible together for storage and being extendable to provide a single elongated guide strip.

5. A guide as in claim 4 wherein the guide strips are interconnected by being hinged together end to end, such that the guide strips are collapsible by being folded together and are extendable by being unfolded.

6. A guide as in claim 1 wherein the clamping means comprise a pair of spaced clamping members mounted on a rear side of the base so as to be laterally movable with respect to each other, the clamping members having gripping flanges extending therefrom that are shaped for clamping engagement with outwardly extending surfaces on opposite sides of corrugations in the sheet material.

7. A guide as in claim 6 wherein the clamping members include gripping surfaces that include a layer of a resilient material having a high coefficient of friction that urges the gripping surfaces to refrain from slipping off the corrugations when the clamping surfaces are clamped on the sheet material.

8. A guide as in claim 6 wherein the clamping members are elongated angle members having a mounting flange that is attached to the base and a gripping flange that extends outwardly from the base, the gripping flange having a gripping surface that is disposed at an angle that correlates sufficiently well with an inclined angle of outwardly extending surfaces of the sheet material corrugations that the clamping engagement of the clamping members, with the surface of the sheet material holds the guide in position for establishing a cut line on the sheet material.

9. A guide as in claim 8 wherein the gripping flanges are disposed at an angle of at least 45 degrees with respect to the mounting flanges.

10. A guide as in claim 8 wherein the gripping flanges are disposed at an angle of approximately 65 degrees with respect to the mounting flanges.

11. A guide as in claim 1 wherein the straight edge has an elongated longitudinal internal slot therein, the straight edge being rotatably mounted on a pivot pin that extends from the base, the straight edge being releasably clamped to the base by a clamping member that is mounted on the pivot pin for axial adjustment between clamped and released positions with respect to the straight edge.

12. A guide as in claim 1 wherein the straight edge is a first straight edge and is extendable by an extension straight edge that is releasably mounted on an end of the first straight edge by a releasable clamp.

13. A guide as in claim 1 wherein the extension straight edge includes at least two sections of straight edge hinged together at abutting ends.

14. A guide as in claim 1 wherein the straight edge is protected by an edge protector that fits on the straight edge and includes a raised flange that extends upwardly past an upper surface of the straight edge on at least one side of the straight edge.

15. A guide as in claim 14 wherein a U-shaped edge protector is mounted on the first straight edge and extends outwardly beyond the end of the first straight edge, so as to provide support for a connection with the extension straight edge.

16. A guide for marking or cutting corrugated sheet material at an oblique angle comprising:
a base plate;
a pair of opposed clamping members mounted on a rear side of the plate and configured to clamp the base plate to the surface of corrugated material by engagement of the clamping members against corrugations on the face of the corrugated sheet material, the clamping members having oppositely inclined gripping surfaces that engage oppositely inclined corrugation surfaces in the sheet material, at least one clamping member being laterally adjustable with respect to the other clamping member between a released position, wherein the clamping members can be removed, and a clamping position, wherein the clamping members exert lateral clamping force on the corrugated material, urging the base to remain in a desired clamped position on the surface of the sheet material, the clamping members having resilient gripping surfaces thereon that enhance the ability of the clamping members to resiliently hold the base in a desired position on the sheet material when the clamping members are in their clamping positions.
